(19) United States
(12) Patent Application Publication
(10) Pub. No.: US 2006/0116816 A1
(43) Pub. Date: Jun. 1, 2006

(54) Systems and methods for providing navigation guidance in pseudo-navigation/automatic direction indicator modes

(75) Inventors: Yi-Chung Chao, Fremont, CA (US); Robert William Rennard, Gilory, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Telenav, Inc., Santa Clara, CA (US)

(21) Appl. No.: 11/280,374

(22) Filed: Nov. 16, 2005

Related U.S. Application Data
(63) Continuation-in-part of application No. 11/004,198, filed on Dec. 1, 2004.

(51) Int. Cl. G01C 21/32

(52) U.S. Cl. 701/210; 701/200; 701/211; 455/456.1; 455/457; 701/26; 701/209

(57) ABSTRACT

Methods and systems for providing navigation guidance in pseudo-navigation/automatic direction indicator modes. Each system includes at least one client integrated with a mobile communication device (e.g. PDA, cellular telephone, etc.) and configured to send a request for information of a nominal route to a server. The server calculates the nominal route and sends the information to the client via wireless carriers and networks. When the user deviates from a nominal route, the client determines a recovery point on the nominal route. Then, the client provides navigation guidance in a pseudo-navigation mode or an automatic direction indicator mode without resorting to the server for a new route until the user recovers on the nominal route via the recovery point.

### CROSS REFERENCE TO RELATED APPLICATIONS

### CROSS REFERENCE TO RELATED APPLICATIONS

This application is a continuation-in-part of U.S. patent application Ser. No. 11/004,198, entitled “Method And System For Multiple Route Navigation” by Chao et al., filed on Dec. 01, 2004, which is incorporated herein by reference in its entirety.

### FIELD OF THE INVENTION

The present invention relates generally to navigation systems, and more particularly, to methods and systems for navigation wherein a client provides navigation guidance in pseudo-navigation/automatic direction indicator modes for the user if the user deviates from a nominal route.

### BACKGROUND OF THE INVENTION

A rapid growth in technological fields such as the personal digital assistant (PDA) and cellular telephones has fueled consumer interest in products that provide on-call real-time guidance and communication. One such technological advance is a navigation system that allows users to reach destinations by providing turn-by-turn instructions along a calculated route.

A variety of systems are known in the art for providing users with electronic routing maps and navigation aids. A typical approach can be found in U.S. Pat. No. 6,898,516 to Pechatnikov et al., which discloses a method for displaying a corridor map on a mobile client. Such a conventional navigation system, however, has several obstacles to overcome. One such obstacle is the amount of geographic data needed to provide reasonably detailed navigational information. Small handheld devices comprise limited embedded memory that may not be adequate for storing a large amount of geographic information essential for navigational purposes.

Due to the limited client memory capacity, conventional distributed navigation systems assign nominal route calculation tasks to the server, and allocate rerouting calculations almost exclusively to the server. Typically, the client requests a rerouting calculation whenever the user deviates from the nominal route. In order to retrieve the calculated result from the server and provide navigation information for the user, the client must frequently communicate with the server. Such constant communication may be time consuming and the information may be inaccurate due to communication delays. In addition, if the client is located in a spot where the signal level is below the minimum threshold for communication, the client cannot retrieve adequate information from the server. Thus, there is a need for a client-based navigation system, wherein the client with limited memory capacity can provide navigation guidance for the user without resorting to the server frequently for a new nominal route when the user deviates from the nominal route.

### SUMMARY OF THE INVENTION

The present invention provides methods and systems for providing navigation guidance for users. Each system includes a client integrated with a mobile communication device (e.g. PDA, cellular telephone, etc.) and configured to send a request for information of a nominal route to a server. The server calculates the nominal route and sends the information to the client via wireless carriers and networks. When the user deviates from the nominal route, the client determines a recovery point on the nominal route. Then, the client provides navigation guidance in a pseudo-navigation mode or an automatic direction indicator mode without resorting to the server for a new route until the user recovers back on the nominal route via the recovery point.

In one aspect of the present invention, there is provided a method for providing navigation guidance for the user of a client. The client stores nominal route information received from a server. Then, the client regularly determines the user's current location and determines if the user has deviated from the nominal route. If the user has deviated from the nominal route, the client determines a recovery point and provides the user with navigation guidance to direct the user to the nominal route via the recovery point.

In another aspect of the present invention, a method for providing navigation guidance for the user of a client is provided. The client sends a request for nominal route information to a server with data including a user's initial location and a destination. Then, the server calculates the nominal route and sends the information to the client. Subsequently, the client receives the information from the server and stores the information in the memory thereof. The client regularly determines the user's current location and checks if the user has deviated from the nominal route. If the user has deviated, the client determines a current recovery point and checks if the user is within a pseudo-navigation deviation threshold. If the user is within the threshold, the client provides navigation guidance in a pseudo-navigation mode. If the user is not within the threshold, it provides navigation guidance in an automatic direction indicator mode. Upon recovery on the nominal route via the recovery point, the client may provide normal navigation guidance until the user reaches the destination.

In still another aspect of the present invention, a method for providing navigation guidance for the user of a client is provided. The client sends a request for information of a nominal route to the server with data including a user's initial location and a destination. Then, the server calculates the nominal route and sends the client the information that is a vector map including a set of coordinates corresponding to the user's initial location, the destination and a set of intermediate points. Subsequently, the client receives and stores the information in its memory. Next, the client regularly determines the user's current location to check if the user has deviated from the nominal route. If the user has deviated, the client determines a current recovery point and checks if the user is within a pseudo-navigation deviation threshold. If the user is within the threshold, the client provides navigation guidance in a pseudo-navigation mode. If the user is not within the threshold, it provides navigation guidance in an automatic direction indicator mode. Upon recovery on the nominal route via the recovery point, the client may provide normal navigation guidance until the user reaches the destination.

In yet another aspect of the invention, a navigation system includes: a client for sending a request for nominal route information to a server with data having a user's initial coordinate and a destination; and a server for receiving the request from the client and in response thereto executing one or more of the following steps: accessing one or more database, generating the nominal route according to the data, and sending to the client the nominal route information. The client is also configured to receive the nominal route information from the server and store the information in its memory. Then, the client regularly checks if the user has deviated from the nominal route. If the user has deviated, the client determines the current recovery point and provides the user with navigation guidance to direct to the current recovery point. The nominal route is a vector map including a set of coordinates corresponding to the user's initial location, the destination and a set of intermediate points.

These and other features, aspects and advantages of the present invention will become better understood with reference to the following drawings, description and claims.

### BRIEF DESCRIPTION OF THE DRAWINGS:

FIG. 1A is a schematic diagram of an interactive real-time navigation system having one or more clients capable of providing navigation guidance for their users in accordance with one embodiment of the present invention.

FIG. 1B is a schematic diagram of an interactive real-time navigation system having one or more clients capable of providing navigation guidance for their users in accordance with another embodiment of the present invention.

FIGS. 2A-B illustrate the multiple-route navigation technique disclosed in a previous embodiment of the present invention.

FIGS. 3A-6B are schematic diagrams illustrating exemplary user cases, each user case including a trajectory map and a sequence of audio/visual displays provided by the clients generally shown in FIGS. 1A-1B.

FIGS. 7A-7C illustrate exemplary turn types to be used by the visual displays depicted in FIGS. 3B, 4B, 5B and 6B according to the present invention.

FIGS. 7D-7E illustrate an exemplary classification of turn types according to the present invention.

FIG. 7F is an exemplary trajectory map having a turn on a nominal route shortly after a recovery on the nominal route.

FIG. 7G is an exemplary visual display layout for notifying the user of the turn shown in FIG. 7F according to one embodiment of the present invention.

FIG. 8A is a schematic diagram of a map illustrating the requirements for transition from an automatic direction indicator mode to a pseudo-navigation mode of the clients generally depicted in FIGS. 1A-1B.

FIG. 8B is a schematic diagram of a map illustrating the requirements for transition from a pseudo-navigation mode to an automatic direction indicator mode of the clients generally depicted in FIGS. 1A-1B.

FIG. 9 is a flow chart illustrating steps that may be carried out to provide navigation guidance according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

It must be noted that, as used herein and in the appended claims, the singular forms “a”, “and”, and “the” include plural referents unless the context clearly dictates otherwise. Thus, for example, reference to “a client” includes one or more clients and equivalents thereof known to those skilled in the art, and so forth.

Broadly, the present invention provides methods and systems for providing navigation guidance for users. Each system may include a client or client device integrated with a mobile communication device (e.g. PDA, cellular telephone, etc.) and configured to receive nominal route information from a server via wireless carriers and networks. Unlike the existing navigation guidance systems, upon detection of a user's deviation from the nominal route, the client may provide navigation guidance for the user without resorting to the server for a new nominal route until the user recovers on the nominal route.

The pseudo-navigation/automatic direction indicator (ADI) guidance capability of the client may allow the client to provide the user with navigation guidance even when the reception level of the client is lower than the minimum threshold and/or the server cannot provide adequate navigational information without delay. As a consequence, the integrity and security of the client's capability of providing navigational guidance may be enhanced.

To provide navigation guidance, a navigation system requires a user's location (or position). It is intended that the term location referred to herein comprises a geographic location or geographic information relating to the position of an object. A location may contain two- or three-dimensional information that completely defines the exact position of an object. Broadly defined, as used herein, a location also may include speed, time, direction of movement, etc. of an object.

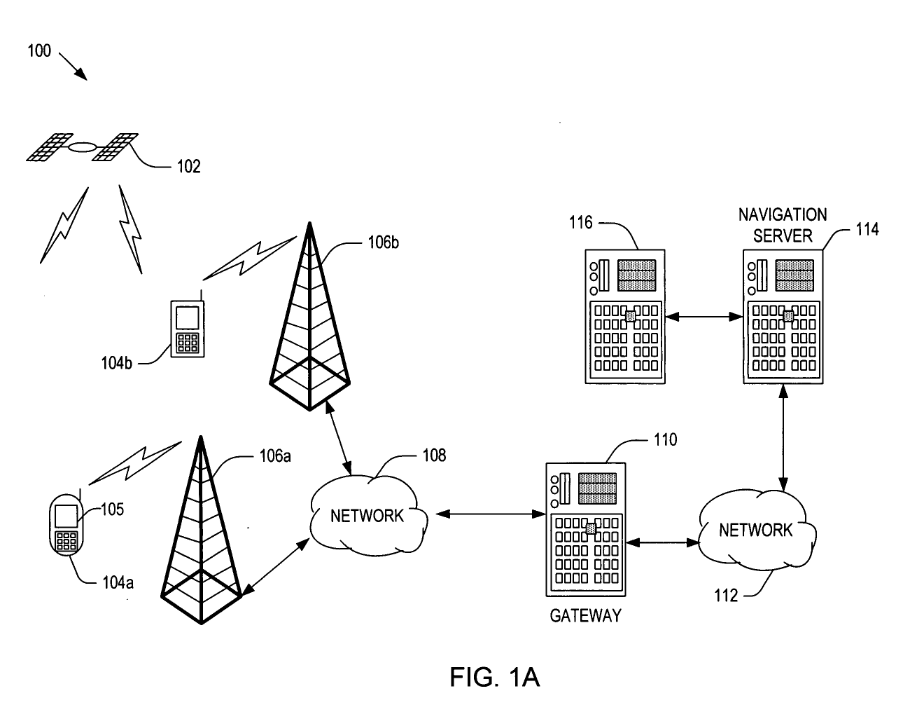

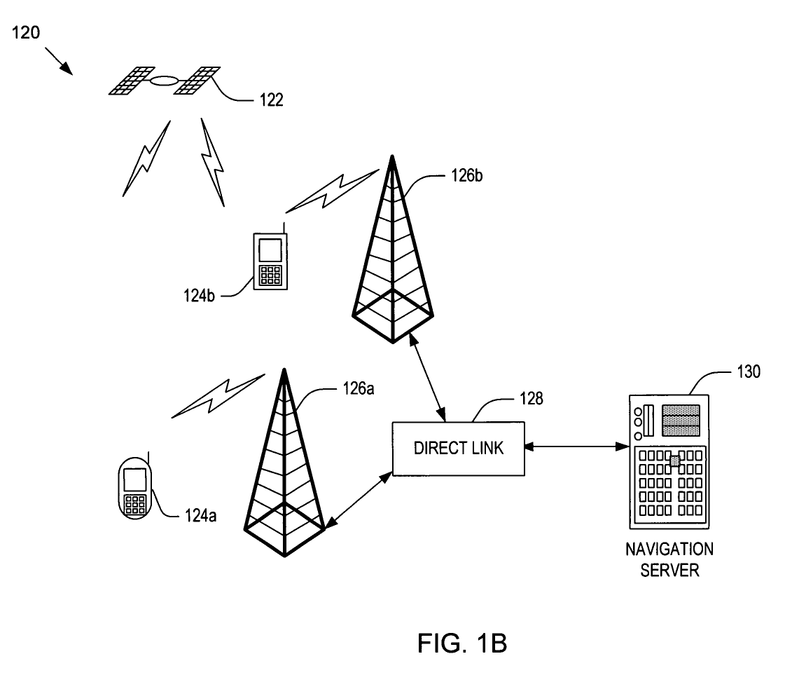

Referring now to FIG. 1A, FIG. 1A is a schematic diagram of an interactive real-time navigation system shown at 100 and having one or more wireless devices 104a-b capable of providing navigation guidance in accordance with one embodiment of the present invention. The wireless devices 104a-b may take the form of a cellular telephone, satellite telephone, wireless Personal Digital Assistant (PDA), personal computer or other suitable device having wireless communications capability. Hereinafter, a term “client device” (or, shortly “client”) may be used interchangeably with the term “wireless device” as one of the major functions of the wireless devices 104a-b may be receiving navigation information from a server 114.

The wireless devices 104a-b may be equipped with positioning capability (or, equivalently, location determination functionality) that takes the form of, for example, Global Positioning Systems (GPS) that may receive signals from a GPS satellite 102, Enhanced 911 (E911), or some other positioning systems as they become available. One skilled in the art will appreciate that the present invention is not limited to any particular positioning technology. In an alternative embodiment, the wireless devices 104a-b may be manufactured with built-in positioning capabilities. In FIG. 1A, only two wireless devices 104a-b are shown for clarity illustration. However, it should be apparent to those of ordinary skill that the present invention may be practiced with other suitable number of wireless devices.

The wireless devices 104a-b may not need to carry map information. As will be explained later, the limitation with respect to the memory and CPU is that the wireless devices 104a-b have sufficient memory to store a nominal route (or, equivalently, a preferred destination route) or multiple routes transmitted from the server 114 and CPU capability to guide the user using the stored route information. In an alternative embodiment, the capabilities of the wireless devices 104a-b may be enhanced through interfacing with modular attachments. Another major function of the wireless devices 104a-b may be to provide an interface between the devices and users.

As will be described more fully below, the wireless devices 104a-b may provide a user interface for displaying graphical, textual or audible information. The user interface incorporates the user's sensory capabilities within the guidance system 100, allowing the user to interact with electromechanical components of the devices 104a-b, such as by allowing the user to relay and receive location information by means of audible, audiovisual, graphical signals, or any combination thereof. Where a text-displaying device is used, enhanced performance is achieved through the wireless devices 104a-b displaying several lines of text. One skilled in the art realizes that many more implementations are possible for the wireless devices 104a-b without deviating from the teachings of the present invention.

In an alternative embodiment, the wireless devices 104a-b may be connected to an accessory display. For example, the wireless devices 104a-b appropriate for walking may be enhanced by interfacing the devices with additional features such as a car-mounted display or portable computer to become better equipped for automobile navigation. In another alternative embodiment, the accessory device provides, without limitation, enhanced display capabilities, enhanced memory capacity, increased computational power, or increased throughput.

Referring back to FIG. 1A, wireless carriers 106a-b may provide wireless connectivity between the wireless devices 104a-b and a navigation server 114 to be described further below. Examples of the wireless carriers 106a-b may include cellular telephone carriers and satellite communications carriers. In achieving wireless connectivity, the wireless carriers 106a-b may provide an existing infrastructure for the wireless devices 104a-b and distributed navigation servers. Because of the adaptive interaction with the user, information ranging from general to very specific may be relayed to the user for a wide range of navigation applications.

While keeping within the teachings of the invention, the wireless carriers 106a-b may provide positioning information for the clients 104a-b. The wireless carriers 106a-b may receive and transmit analog or digital information from the wireless devices 104a-b and direct such information downstream to other components of the system 100. Similarly, the wireless carriers 106a-b may receive information from components of the system 100 and then direct such information to the wireless devices 104a-b.

As shown in FIG. 1A, the wireless carriers 106a-b may be connected to a gateway 110 via a network 108, wherein the gateway 110 may be further connected to the navigation server 114 through another network 112. The gateway 110 may be provided by, among others, wireless carriers, ISPs, or other telecommunications providers while the networks 108 and 112 may be the Internet. The Internet provides advantages because it is a widely distributed network reaching many areas of the world. In an alternative embodiment, the networks 108 and 112 may be implemented as a proprietary network. By implementing a specialized network, the networks 108 and 112 may be customized to provide minimal latency and optimal performance.

As shown in FIG. 1A, the navigation server 114 may provide navigation information for the wireless devices 104a-b via the network 112. The navigation server 114 may comprise street map information, traffic, weather, and other navigation-related as well as points of interest information to facilitate accurate navigation and flexibility. In this manner, the wireless devices 104a-b may be not burdened with carrying all the necessary information required to process proper navigation. In an alternative embodiment, the navigation server 114 may also process location specific information such as real-time traffic information. In another alternative embodiment, traffic information may be obtained from a separate server 116 of other service providers. By observing and comparing their positions, speeds and times, and making further comparisons with nominal street speed limits in a map database, real-time traffic information may be generated by the server 116 and then directed to the navigation server 114. At each request of a nominal route calculation from the wireless devices 104a-b, the navigation server 114 may dynamically determine a new nominal route or multiple routes for a particular user responsive to ever changing conditions. The nominal and multiple routes will be detailed later.

FIG. 1B is a schematic diagram of an interactive real-time navigation system shown at 120 and having one or more clients capable of providing navigation guidance for their users in accordance with another embodiment of the present invention. As illustrated, a wireless devices 124a-b, a GPS satellite 122, wireless carriers 126a-b and a navigation server 130 may be substantially similar to their counterparts described in FIG. 1A. Direct links 128, however, provide an alternative embodiment to the function of the gateway 110 and networks 108 and 112 of FIG. 1A. The direct link architecture is applicable where Internet infrastructure is not well established or fast response is desired for user navigation or other location specific information services. Illustratively, T1, Frame Relay, etc. linked by a LAN or WAN are appropriate for the direct link 128. In an alternative embodiment, the direct link 128 may be implemented as hard-wired connections between the wireless carriers 126a-b and the navigation server 130 where the wireless carriers 126a-b and the navigation server 130 are collocated in a central office.

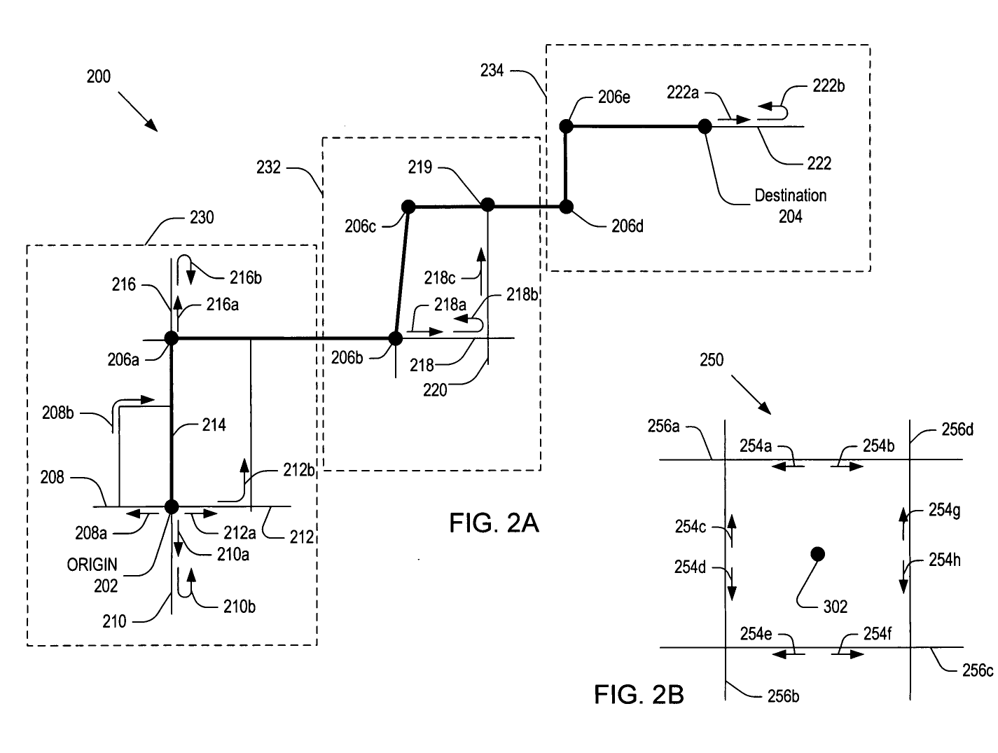

FIG. 2A is a schematic diagram of server-calculated multiple routes from a user origin to a destination in accordance with the previous embodiment of the present invention. As illustrated, multiple routes shown at 200 may be a vector map and include the user's initial location (or, equivalently origin) 202, destination 204, preferred or nominal route 214, intermediate points 206a-e and road branches 208, 210, 212, 216 and 218. By the term “vector map” is meant that each of the multiple routes comprises a set of coordinates. For the purpose of illustration, only five intermediate points 206a-e and six road branches 208, 210, 212, 216, 218 and 222 are shown in FIG. 2A. However, it should be apparent to those of ordinary skill in the art that the present invention can be practiced with other suitable number of intermediate points and branches.

To generate the multiple routes in FIG. 2A, the navigation server 114 in FIG. 1 may receive GPS information from a client, say 104a, to determine the origin 202. Further details of the process for determining the origin 202 is found in U.S. patent application Ser. No. 11/004,198, filed on Dec. 01, 2004, which is the parent of the present application. The navigation server 114 may also receive the destination information from the client 104a to calculate the multiple routes. The user 104a may select a destination from a list of his/her most recent destinations, a preplanned trip itinerary or an address booklist. In an alternative embodiment, the user may input the destination information into the client via a user interface, such as keyboard.

Then, based on the origin 202 and destination 204, the navigation server 114 may determine the multiple routes shown at 200 and sends the multiple routes information to the client 104a. Each of the road branches 208, 210, 212, 216, 218 and 222 represents a route that the user can take intentionally or unintentionally deviating from the preferred or nominal route 214.

Upon receipt of the multiple routes information from the server, the client 104a may store the information in its memory. Then, as the user starts navigation from its origin 202 toward the destination 204 along the preferred route 214, the client 104a may provide the user with turn-by-turn instructions along the preferred route 214. During the navigation, the user may take one of the branches 208, 210, 212, 216, 218 and 222. Typically, the client 104a may regularly update its user location and direction based on the GPS information received from the satellite 102 (FIG. 1A). When the client 104a detects a deviation from the preferred route 214 into one of the branches 208, 210, 212, 216, 218 and 222, it may provide the user with guidance using the multiple routes 200 without resorting to the navigation server 114. For example, the client 104a may suggest a u-turn 210b when the user is on the road 210 and proceed in the direction 210a. Likewise, when the user travels on branch (or, equivalently, road) 208, 212 or 216 and proceeds in the direction 208a, 212a or 216a, the user may be guided back to the preferred route 214 by an instruction following the direction 208b, 212b or 216b, respectively.

At the intersection 206b, the user may proceed in a direction 218a. Then, the client 104a may guide the user back to the preferred route 214 by a u-turn on the branch 218b or an alternative approach 218c along a road 220. At the destination 204, the user may overshoot as indicated by an arrow 222a. Then, the client 104a may guide the user to the destination by a u-turn 222b. If the user deviates from the region covered by the multiple routes 200, the client 104b may send a request for new multiple routes to the navigation server 114.

The amount of navigation information received by a client may depend on factors such as user-designated settings or storage and/or processing capabilities of the client. For example, the client 104a may receive navigation information for the entire multiple routes shown at 200 from origin 202 to destination 204. Alternatively, the navigation server may divide the multiple routes into several sections, such as sections 230, 232 and 234, of constant (e.g. 100 feet per section) or varying (e.g. 50 feet from the user initial position for the first section, 100 feet for the second section, etc.) distances, and the client receives and stores multiple route information for the next section at the end of the current section or the beginning of the next section.

FIG. 2B is a schematic diagram illustrating multiple routes shown at 250 near an origin in accordance with another previous embodiment of the present invention. As illustrated, the origin 252 may be located in a parking lot or a shopping mall surrounded by four roads 256a-256d. In this case, navigation server 114 may not be able to determine which direction the user may select from eight possible directions 254a-h. Thus, the navigation server 114 may calculate multiple routes 200 that may include all of the possible scenarios. Using the calculated multiple routes shown at 200 and 250, the client 104a can guide the user without requesting a new multiple routes unless the user deviates from the multiple routes.

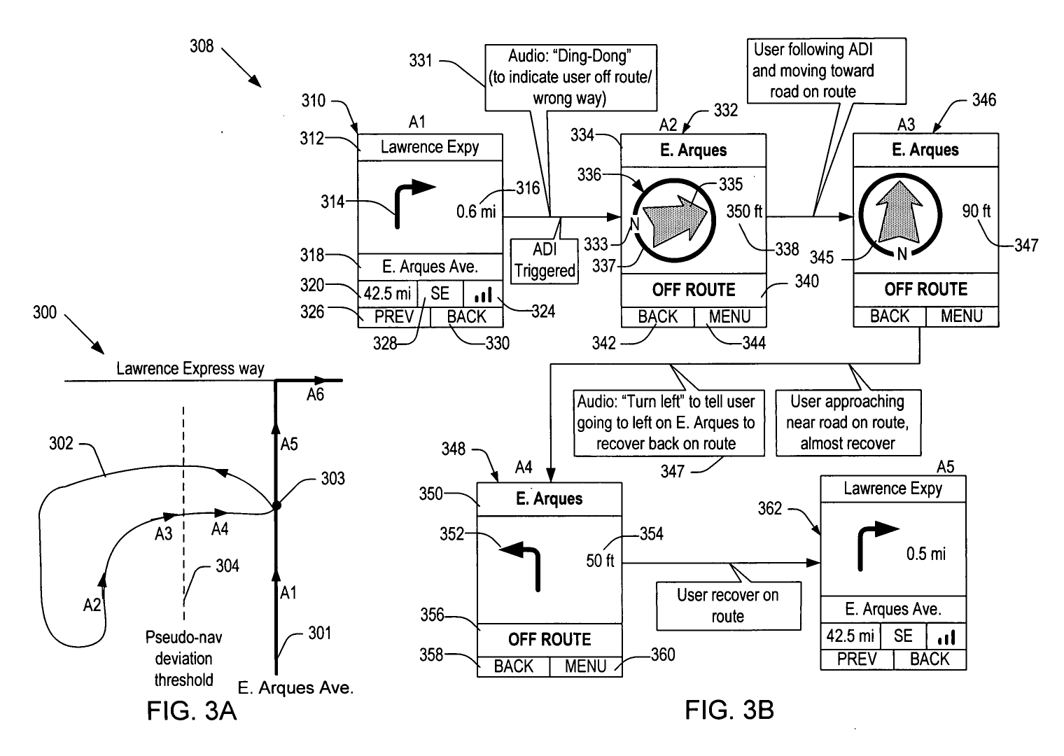

As illustrated in FIGS. 2A-2B, the multiple-route approach may require a receiving client to have a storage or memory capacity sufficient for the multiple route data. However, in some cases, the client, say 104b, may be a small handheld device that does not have enough memory to store the information for at least one divided section, say 232. In addition, if the origin 252 is located in a parking lot as illustrated in FIG. 2B, the size of the multiple routes information may be large due to the possible scenarios and exceed the storage capacity of the client. In other cases, the received signal level at the client 104a may be below the minimum threshold preventing the client 104a from sending a request for new route information to or receiving route information from the server while the user may be traveling away from the multiple routes. To reinforce the capabilities of the clients having one or more of these difficulties, the clients 104a-b may be configured to store the information of the preferred or nominal route 214 and provide autonomous navigation guidance for the user without resorting to the server for a new route until the user recovers on the preferred or nominal route 214. The autonomous navigation guidance may be provided by an autonomous guidance system, which may be preferably a program stored in the clients 104a-b and include pseudo-navigation (or shortly, pseudo-nav) system and Automatic Direction Indicator (ADI) system, which are detailed in connection with FIGS. 3A-9.

FIG. 3A is a schematic diagram of an exemplary trajectory map shown at 300 and having a trajectory 302 taken by the user of a client, say 104b, in FIG. 1A-1B. As illustrated, the user may deviate from a nominal route 301 and recover on the nominal route 301 by use of the autonomous navigation guidance provided by the client 104b, more specifically autonomous guidance system of the client. (Hereinafter, it is assumed that the client has a memory capacity sufficient for storing at least the nominal route. The client may send a request for and receive multiple routes information if it has a sufficient memory.) As the user is off the nominal route 301 and travels along the trajectory 302, the client 104b may provide autonomous navigation guidance by means of audible, audiovisual, graphical signals, or any combination thereof. For example, FIG. 3B is a sequence of instructions provided by the client 104b, where the sequence shown at 308 includes audio signals and visual displays presented on the display monitor or visual display interface 105 of the client 104b when the user passes through the points A1-A5.

When the user passes through the point A1 on E. Arques Avenue, the client 104b may provide normal navigation guidance for the user by means of a visual display 310. (Hereinafter, the term normal navigation guidance refers to the guidance provided when the user travels on a nominal route.) The visual display 310 may include an approaching street name 312, a turn-type arrow 314 for indicating the type of turn to be made at the approaching street, a distance indicator 316 for indicating the distance to the approaching street, the current street name 318, a trip counter or distance meter 320 for indicating the distance to a destination, a direction indicator 328 for indicating the current moving direction, a signal level indicator 324 for indicating signal intensity level and two menu windows 328 and 330. It should be apparent to those of ordinary skill that the visual display 310 may have other suitable layout design and less or more display elements to meet the needs of a particular application.

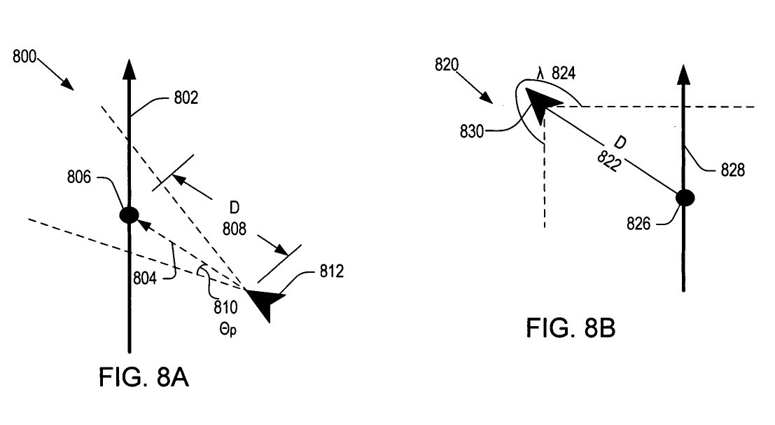

As the user deviates from the nominal route 301, the client 104b may prompt the user by playing a chime “Ding-Dong” as shown in a text bubble 331. Also, the autonomous guidance system may determine a recovery point or automatic direction indicator (ADI) entry point 303 on the nominal route 301. The recovery point may be a point on the nominal route where the user deviates from the nominal route. The recovery point can also be determined by the user's closest street accessible point, given user's position, heading and distances to streets surrounding the user's position. If available, the determination of recovery point can utilize street accessible information, like front gate, fence or curb related information. If the user proceeds further and deviates from a pseudo-navigation deviation threshold 304, the ADI system of the client 104b may be triggered. The determination of the pseudo-navigation deviation threshold will be detailed in connection with FIGS. 8A-8B.

The ADI system may provide navigational guidance in an ADI mode, where the guidance may take the form of audio signals and/or visual displays on the display monitor 105 (FIG. 1A). For example, when the user passes through the point A2, the ADI system may present a visual display 332. The visual display 332 may include a name of the street 334 having the recovery point 303 on the nominal route 301, a direction indicator 336 for pointing to the recovery point 303, a distance indicator 338 for indicating the distance to the recovery point 303, a text message 340 for indicating the user's current status and two menu windows 342 and 344. The direction indicator 336 may be in the form of an arrow 335 enclosed by a circle 337 and include a notation 333 for indicating the north. The direction indicated by the arrow 335 may correspond to the vector from the user to the recovery point 303. It should be apparent to those of ordinary skill that the visual display 332 may have other suitable layout design and less or more display elements to meet the needs of a particular application.

When the user passes through the point A3, the ADI system may present a visual display 346 that is similar to the display 332 with the difference that the direction indicator 345 and distance indicator 347 may have updated information. As the user further approaches the recovery point 303 and travels within the pseudo-navigation deviation threshold 304, the pseudo-navigation system may be triggered to provide navigation guidance in a pseudo-navigation mode. In this mode, the client may provide prompts by means of audio signal and/or visual display. For example, the client may prompt the user by playing an audio signal for a turn instruction, such as “Turn left” as shown in a text bubble 347. The client may also display a visual display 348, where the visual display 348 may include a name of the street 350 having the recovery point 303 on the nominal route 301, a direction indicator 352 for instructing a turn at the recovery point 303, a distance indicator 354 for indicating the distance to the recovery point 303, a text message 356 for indicating the user's current status and two menu windows 358 and 360. As the user recovers on the nominal route 301, the client may present a visual display 362 that is similar to the display 310.

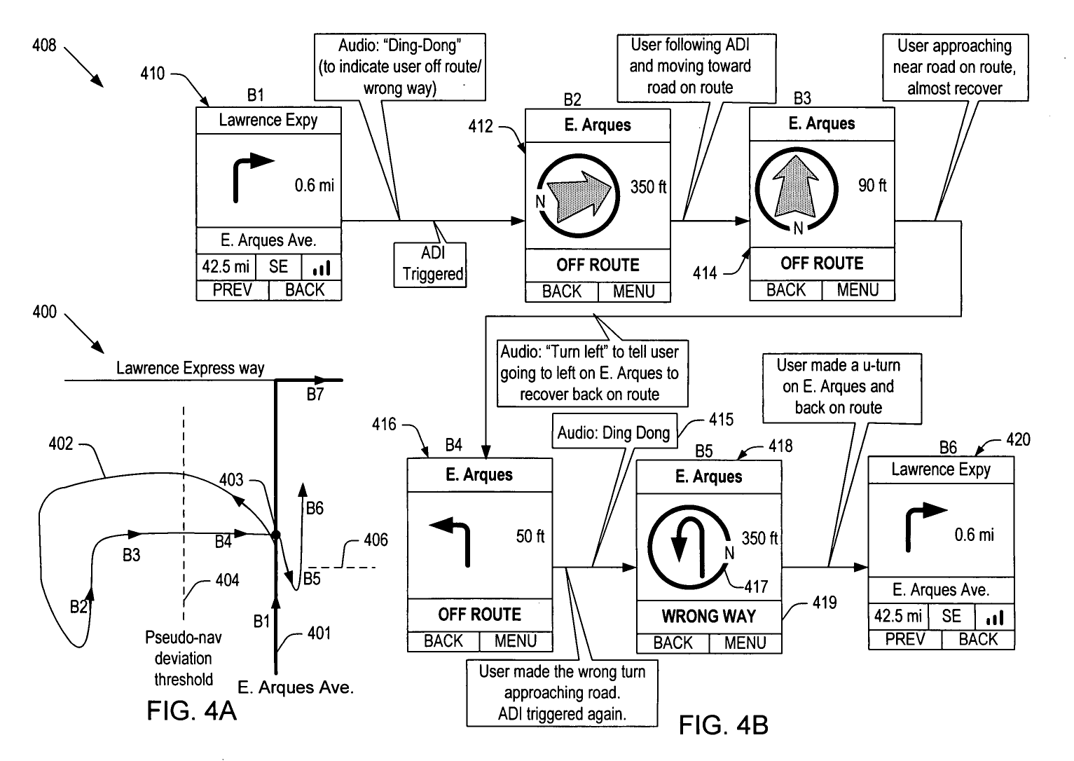

FIG. 4A is a schematic diagram of another exemplary trajectory map shown at 400 and having a trajectory 402 taken by the user of a client, say 104b, in FIGS. 1A-1B. As illustrated, the user may deviate from a nominal route 401 and recover on the nominal route 401 by use of the autonomous navigation guidance provided by the client 104b. As in the case of FIG. 3A, the client may provide autonomous navigational guidance by means of audible, audiovisual, graphical signals, or any combination thereof. FIG. 4B is a sequence of instructions provided by the client, where the sequence shown at 408 includes audio signals and visual displays presented on the display monitor or visual display interface 105 of the client 104b when the user passes through the points B1-B6.

The visual displays 410, 412, 414 and 416 corresponding to the points B1-B4, respectively, are quite similar to the displays 310, 332, 346, and 348 in FIG. 3B. As the user makes a wrong turn at the recovery point 403 and deviates from a pseudo-navigation threshold 406, the ADI system may be triggered again and prompt the user as shown in a bubble text 415 by playing a chime “Ding-Dong” and present a display 418. The display 418 may be similar to the display 414 with two differences. Firstly, the display 418 has an arrow 417 to notify a u-turn of the user. Secondly, the text message 419 shows “WRONG WAY,” instead of “OFF ROUTE.” When the user makes a u-turn on E. Arques avenue and passes through a point, say the point B6, on the nominal route 401, the client may present a display 420 that is similar to the display 410 in the normal mode.

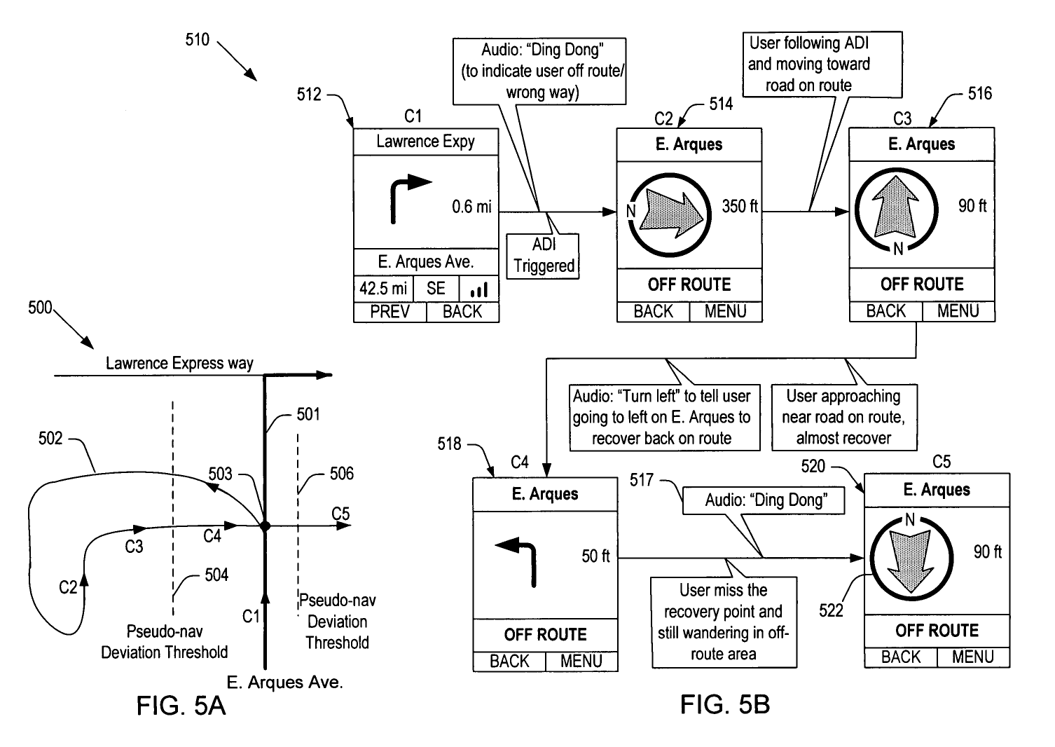

FIG. 5A is a schematic diagram of still another exemplary trajectory map shown at 500 and having a trajectory 502 taken by the user of a client, say 104b, in FIGS. 1A-1B. As illustrated, the user may deviate from a nominal route 501, be guided by the autonomous navigation system toward the recovery point 503 and fail to make a left turn at the recovery point 503 intentionally or unintentionally. FIG. 5B is a sequence of instructions provided by the client 104b, where the sequence shown at 510 includes audio signals and visual displays presented on the display monitor of the client 104b when the user passes through the points C1-C5.

The visual displays 512, 514, 516 and 518 corresponding to the points C1-C4, respectively, are quite similar to the displays 310, 332, 346, and 348 in FIG. 3B. As the user does not make a left turn at the recovery point 503 and deviates from the pseudo-navigation threshold 506, the ADI system may be triggered again and prompt the user as shown in a bubble text 517 by playing a chime “Ding-Dong” and present a display 520 on the display monitor of the client. The display 520 may be similar to the display 514 and have an arrow 522 to notify the user of a u-turn.

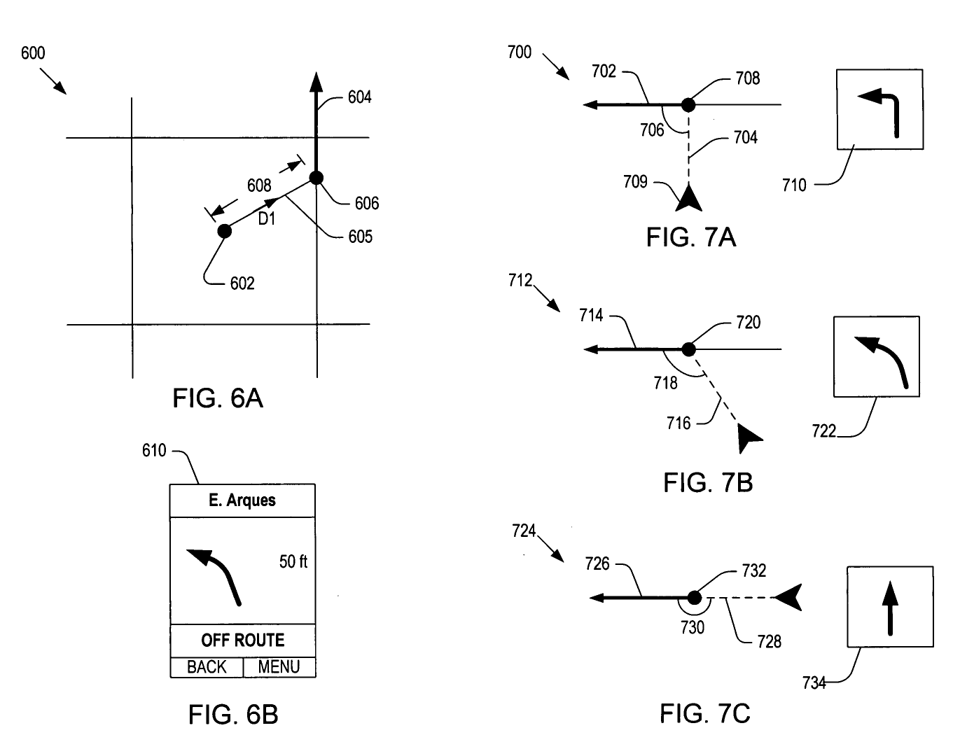

FIG. 6A is a schematic diagram of yet another exemplary trajectory map shown at 600 and having a trajectory 605 taken by the user of a client, say 104b, in FIGS. 1A-1B. As illustrated, the map shown at 600 may include an origin 602 of the user and a nominal route 604, where the user may be guided by the autonomous guidance system to a recovery point 606. FIG. 6B shows a visual display 610 that may be presented on the display monitor of the client when the user passes through a point D1 on the trajectory 605, where the display 610 is similar to the display 518 in FIG. 5B. In FIG. 6B, it is assumed the distance 608 is smaller than the pseudo-navigation threshold. However, if the distance 608 is greater than the pseudo-navigation threshold, the ADI system may be triggered and present a display similar to the display 346 in FIG. 3B prior to presentation of the display 610.

In FIGS. 3A-5B, the autonomous guidance system may lock a recovery point when the user deviates from a nominal route. In an alternative embodiment, the recovery point may move along the nominal route as the autonomous guidance system can update the recovery point based on the user's current location information including the velocity, heading and distance from the user to the nominal route. For example, the client 104b may have information of the nominal route 214 only. If the user deviates at the intermediate point 206b onto a branch 218 in FIG. 2A, the recovery point may be the intermediate point 206b or a newly determined recovery point (or, equivalently ADI entry point) 219 if the user is traveling on the branch 218 or 220, respectively.

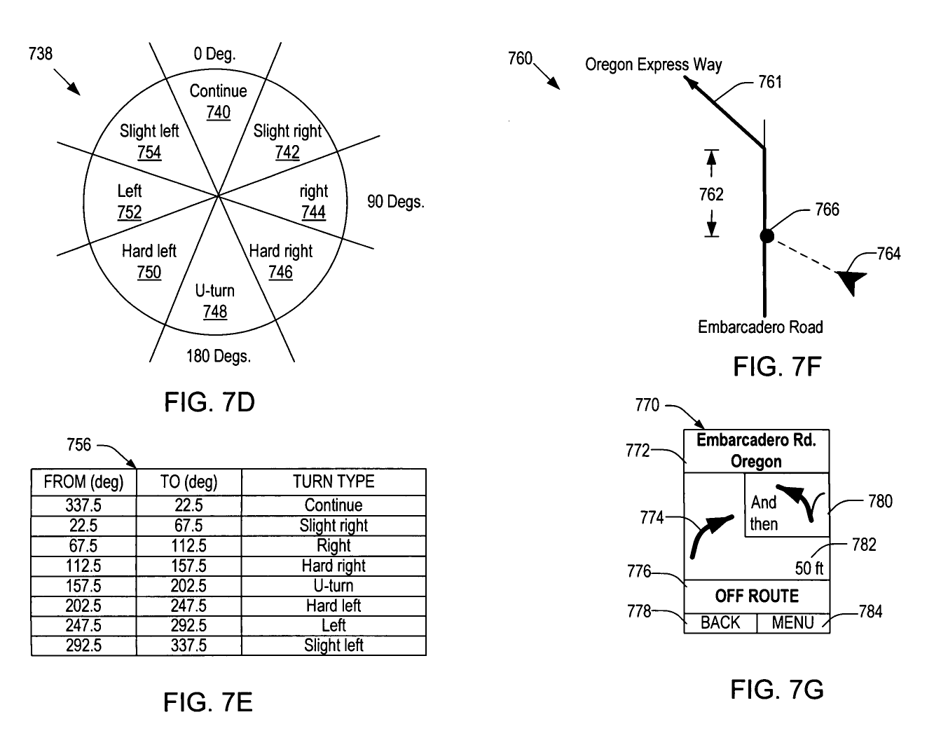

As shown in the display 348 (FIG. 3B), the display 348 may include an arrow 352 for indicating a turn to be made at the recovery point 303. FIG. 7A is a schematic diagram of a map shown at 700 illustrating an exemplary turn type and a corresponding arrow 710 to be displayed. As depicted, the user indicated by an arrow 709 may travel along a road 704 to approach a recovery point 708 on a nominal route 702. If the angle 706 between the nominal route 702 and the road 704 is about 90 degrees, a left-turn arrow 710 may be displayed. FIGS. 7B-C illustrate other exemplary turn types, where the arrows 722 and 734 may correspond to the angles 718 and 730, respectively.

As the number of arrow types to be displayed may be limited, each arrow may be used to represent an appropriate angular range. For example, FIGS. 7D-7E illustrate a classification of turn types, where each turn type, say Left 752 in FIG. 7D, may cover an angular range from 247.5 to 292.5 degrees and be represented by the arrow 710 (FIG. 7A).

If a nominal route has a turn shortly after a recovery, the display 348 (FIG. 3) may include another arrow to indicate the turn. For example, as illustrated in FIG. 7F, the user indicated by an arrow 764 may make a first turn at a recovery point 766 on the Embarcadero road followed by a second turn on the Oregon Express Way to remain on the nominal route 761. If the distance 762 between the two consecutive turns is less than a predetermined lower limit, a display presented to the user prior to the first turn may include an additional arrow. FIG. 7G illustrates an exemplary display 770 that may include an additional arrow 780 for indicating the second turn on the nominal route 761. As illustrated, the section 772 may include two road names where the two consecutive turns are to be made. The other elements shown in the display 770 may be similar to those of the display 348 (FIG. 3) and not detailed for simplicity.

As illustrated in FIGS. 3A-5B, the automatic direction indicator (ADI) system may be triggered as the user travels away from a recovery point and crosses a pseudo-navigation deviation threshold. Then, the client may make a transition from a pseudo-navigation mode to an ADI mode. Likewise, when the user travels toward the recovery point and crosses the pseudo-navigation deviation threshold, the pseudo-navigation system may be triggered and start providing guidance in a pseudo-navigation mode, i.e., the autonomous guidance system may make a transition from the ADI mode to the pseudo-navigation mode. FIG. 8A is a schematic diagram of a map shown at 800 illustrating the two requirements for transition from an ADI mode to a pseudo-navigation mode of the clients generally depicted in FIGS. 1A-1B. As illustrated, the map shown at 800 may include a nominal route 802, a recovery point 806 and a user's current (GPS) location indicated by an arrow 812, while the pointing direction of the arrow 812 may indicate the user's current heading. The first requirement for transition may be that the distance D 808 from the position of current user 812 to the recovery point (or, equivalently ADI entry point) 806 is within a certain threshold Tₚ, i.e., D<Tₚ. Secondly, the user's current heading, indicated by a vector 804, may be aligned with the recovery point 806 within a certain limit θₚ.

As mentioned, the client may have a positioning capability, such as GPS, and determine the user's heading (referred to as GPS heading) based on the user's velocity. However, if the velocity is smaller than a certain threshold, the autonomous guidance system may generate an invalid heading angle. If the velocity is below the threshold, a position calculated heading can be used in place of the GPS heading, where the position calculated heading is derived from the vector 804 subtracting the current GPS position 812 from the recovery point position 806.

The autonomous navigation system may make a transition from a pseudo-navigation mode to a normal navigation mode as the user recovers on a nominal route via a recovery point. The user may be considered to have recovered if the distance from the recovery point to the user's position is less than a threshold distance (or equivalently snap distance) and the user is heading toward the recovery point. If the user's velocity is smaller than a threshold velocity, the autonomous guidance system may generate an invalid heading angle. In such a case, the position calculated heading may be used in place of the GPS heading.

FIG. 8B is a schematic diagram of a map shown at 820 illustrating the requirements for transition from a pseudo-navigation mode to an automatic direction indicator (ADI) mode of the clients generally depicted in FIGS. 1A-1B. As illustrated, the map shown at 820 may include a nominal route 828, a recovery point 826 and an arrow 830 indicating the user's current location and heading, where an angle λ 824 may represent the valid user's field of view. The field of view may be determined by expanding an angle in both directions (+/−λ/2) from the user's current heading. If the distance D 822 from the current position 830 to the recovery point 826 exceeds a threshold and the recovery point 826 lies outside of the field of view, the autonomous guidance system may make a transition from the pseudo-navigation mode to ADI mode by triggering the ADI system. Then, the ADI system may present a visual display, such as display 418 (FIG. 4B) or 520 (FIG. 5B), depending on whether the user travels along the nominal route.

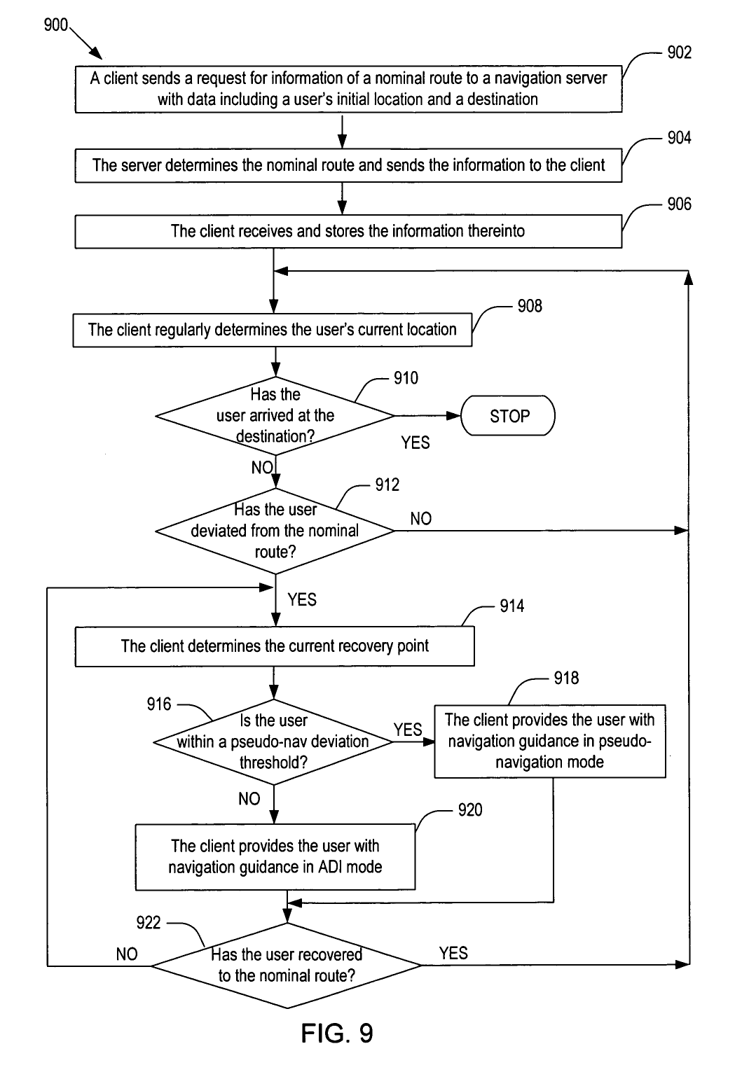

FIG. 9 is a flow chart shown at 900 illustrating steps that may be carried out to provide navigational guidance according to the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

The process may begin in a state 902. In the state 902, a client may send a request for information of a preferred or nominal route to a navigation server with data including a user's initial location (or, equivalently origin) and a destination. The user may select a destination from a list of his/her most recent destinations, a preplanned trip itinerary or an address booklist. In an alternative embodiment, the user may input the destination data to the client. It is noted that the client may send a request for multiple routes information as shown in FIGS. 2A-2B if the client has a memory sufficient for the multiple route information. Then, the process may proceed to a state 904.

In the state 904, based on the origin and destination data, the server may determine a nominal route and send the nominal route information to the client via a wireless communication, wherein information is preferably in a form of a vector map. Next, in a state 906, the client receives and stores the information into the memory thereof.

In a state 908, the client may regularly determine the user's current location based on positioning information, wherein the positioning information may be provided by a positioning mechanism, such as GPS, of the client. Then, in a state 910, the process may determine whether the user has arrived at the destination. If the user has arrived, the process may stop. Otherwise, the process may advance to a state 912.

In the state 912, a determination may be made as to whether the user has deviated from the nominal route. Upon negative answer to the decision block 912, the process may return back to the state 908 to determine the user's current location. Upon affirmative answer to the decision block 912, the process may proceed to a state 914.

In the state 914, the client may determine the current recovery point. Next, in a state 916, a client may decide if the user is within a pseudo-navigation deviation threshold from the current recovery point. Upon positive answer to the decision block 916, the process may advance to a state 918. In the state 918, the client may provide the user with navigation guidance in a pseudo-navigation mode. Subsequently, the process may proceed to a decision block 922. Upon negative answer to the decision block 916, the process may advance to a state 920. In the state 920, the client may provide the user with navigational guidance in an ADI mode. Then, the process may proceed to the decision block 922.

In the decision block 922, a determination is made as to whether the user has recovered on the nominal route via the recovery point. If the user is on the nominal route, the process may proceed to the state 908. Otherwise, the process may proceed to the state 914 to repeat the steps 914-920.

It should be understood, of course, that the foregoing relates to exemplary embodiments of the invention and that modifications may be made without departing from the spirit and scope of the invention as set forth in the following claims.

What is claimed is:

1. In a navigation system comprising a remote sever and a client having a memory and a location determination functionality, a method of providing navigation guidance for the user of said client, comprising:
receiving a nominal route information from said server;
storing said nominal route information into said memory of said client;
using said stored nominal route information and location data determined by said client, causing said client to determine whether said user has deviated from said nominal route;
causing said client to determine a recovery point on said nominal route; and
using said stored nominal route information, causing said client to provide navigation guidance to direct said user to said recovery point if the user has deviated from said nominal route.

2. The method of claim 1, further comprising, prior to the step of receiving a nominal route information:
sending a request for said nominal route information to said server with data including a user's initial location and a destination.

3. The method of claim 2, wherein said destination is selected by said user from the group consisting of a list of user's most recent destinations, a preplanned trip itinerary and an address booklist.

4. The method of claim 2, wherein said nominal route information includes a vector map that includes a set of coordinates corresponding to said user's initial location, destination and a set of intermediate points.

5. The method of claim 1, wherein said step of causing said client to provide navigation guidance includes the steps of:
causing said client to determine whether said user is within a pseudo-navigation deviation threshold; and
if said user is within a pseudo-navigation deviation threshold,
causing said client to provide said user with said navigation guidance in a pseudo-navigation mode, and
otherwise,
causing said client to provide said user with said navigation guidance in an automatic direction indicator mode.

6. The method of claim 5, said step of causing said client to determine whether said user is within a pseudo-navigation deviation threshold includes:
using the location data, causing said client to determine whether a distance from said user to said recovery point is less than a preset threshold value; and
causing said client to determine whether said current recovery point is within a field of view of said user.

7. The method of claim 1, wherein said navigation guidance includes at least one selected from a group consisting of an audible signal, an audiovisual signal, a graphical signal and a visual display on said client.

8. The method of claim 7, wherein said visual display includes an arrow that corresponds to a vector from a user's current location to the recovery point.

9. The method of claim 1, wherein said recovery point is a location where the user deviates from the nominal route.

10. The method of claim 1, wherein said recovery point is the user's closest street accessible point and is determined based on recovery information including a user's position, a user's heading and at least one distance from the user's position to a street surrounding the user's position.

11. The method of claim 10, wherein the recovery information further includes data for a front gate, a fence and a curb.

12. The method of claim 1, wherein the step of causing said client to determine a current recovery point includes the step of:
locking said recovery point when said user deviates from said nominal route.

13. The method of claim 1, wherein the step of causing said client to determine a current recovery point includes the step of:
updating said current recovery point while said user is off said nominal route.

14. The method of claim 1, wherein said client is one selected from the group consisting of a cellular phone, a satellite telephone, a wireless personal digital assistant and a personal computer.

15. A method of providing navigation guidance for the user of a client configured to communicate with a remote server, said client having a memory and a location determination functionality, said method comprising:
(a) sending a request for nominal route information to said server with data including a user's initial location and a destination;
(b) receiving said information from said server and storing said information into said memory of said client;
(c) causing said client to determine a user's location using the location determination functionality;
(d) using said stored nominal route information and said user's location, causing said client to determine whether said user has deviated from said nominal route; and
if said user has deviated,
(i) causing said client to determine a recovery point;
(ii) causing said client to determine whether said user is within a pseudo-navigation deviation threshold, wherein, if said user is within said threshold, further comprising the step of providing said navigation guidance in a pseudo-navigation mode, and wherein, if said user is not within said threshold, further comprising the step of providing said navigation guidance in an automatic direction indicator mode; and
(iii) causing said client to determine whether said user has recovered on said nominal route via said recovery point, wherein, if said user has not recovered on said nominal route, further comprising the step of repeating the steps (i)-(iii), and wherein if said user has recovered on said nominal route, further comprising the step of repeating the steps (c)-(iii); and
(e) repeating steps (c)-(iii) until said user reaches said destination.

16. The method of claim 15, wherein said navigation guidance includes at least one selected from the group consisting of an audible signal, an audiovisual signal, a graphical signal and a visual display on said client, and wherein said visual display includes an arrow corresponding to a vector from said user's location to said recovery point.

17. A method of providing navigation guidance for a user of a client having a memory and being configured to communicate with a server, said method comprising:
(a) sending a request for information of a nominal route from said client to said server with data including a user's initial location and a destination;
(b) causing said server to calculate said nominal route;
(c) sending said information from said server to said client, said information being a vector map including a set of coordinates corresponding to said user's initial location, said destination and a set of intermediate points;
(d) storing said information in said memory;
(e) causing said client to determine a user's current coordinate;
(f) using said user's current coordinate and stored information, causing said client to determine whether said user has deviated from said nominal route; and
if said user has deviated,
(i) causing said client to determine a recovery point;
(ii) causing said client to determine whether said user is within a pseudo-navigation deviation threshold; wherein, if said user is within said threshold, further comprising the step of providing navigation guidance in a pseudo-navigation mode, and wherein, if said user is not within said threshold, further comprising the step of providing navigation guidance in an automatic direction indicator mode; and
(iii) causing said client to determine whether said user has recovered on said nominal route, wherein, if said user has not recovered on said nominal route, repeating the steps (i)-(iii), and wherein if said user has recovered on said nominal route, repeating the steps (e)-(iii).

18. A navigation system, comprising:
a client for sending a request for information of a nominal route to a server, receiving said information from said server, storing said information in a memory of said client, regularly checking if said user has deviated from said nominal route and, if said user has deviated, executing the steps of: determining a recovery point and providing said user with navigation guidance by displaying one or more arrows pointing said recovery point, wherein said request includes a user's initial location and a destination; and
a server for receiving said request from said client and in response thereto executing one or more of the following steps: accessing one or more database, generating said nominal route according to said user's initial location and said destination, and sending said client said information,
wherein said nominal route is a vector map including a set of coordinates corresponding to said user's initial location, said destination and a set of intermediate points.

19. The navigation system of claim 18, further comprising a wireless carrier coupled to said client for receiving said request from said client and also coupled to said server for relaying said request from said client to said server.

20. The navigation system of claim 19, further comprising one or more direct links coupled to said wireless carrier for receiving said request from said wireless carrier and also coupled to said server for relaying said request from said wireless carrier to said server.

21. The navigation system of claim 19, further comprising a gateway coupled to said wireless carrier for receiving said request from said wireless carrier and also coupled to said server for relaying said request from said wireless carrier to said server.

22. The navigation system of claim 21, further comprising a network coupled to said gateway for receiving said request from said gateway and also coupled to said server for relaying said request from said gateway to said server.

23. In a navigation system including a server for receiving a request for information of a nominal route from a client, determining said nominal route and sending said information to said client, one or more wireless carriers operatively coupled to said client, a direct line for operatively coupling said server with said wireless carriers, and a client having a memory and a location determination functionality, an improved client configured to perform the steps of:
receiving a nominal route information from said server;
storing said nominal route information into said memory of said client;
using said stored nominal route information and location data determined by said client, causing said client to determine whether said user has deviated from said nominal route;
causing said client to determine a recovery point on said nominal route; and
using said stored nominal route information, causing said client to provide navigation guidance to direct said user to said recovery point if the user has deviated from said nominal route.
